(19) United States
(12) Patent Application Publication
(10) Pub. No.: US 2009/0042117 A1
(43) Pub. Date: Feb. 12, 2009

(54) CONDUCTIVE MEMBER, AND PROCESS CARTRIDGE AND IMAGE FORMING APPARATUS INCLUDING THE CONDUCTIVE MEMBER

(75) Inventors: Makoto NAKAMURA, Ebina-shi (JP); Yutaka Narita, Sagamihara-shi (JP); Tadayuki Oshima, Atsugi-shi (JP); Hiroki Furubayashi, Atsugi-shi (JP); Taisuke Tokuwaki, Sagamihara-shi (JP)

Correspondence Address: COOPER & DUNHAM, LLP, 30 Rockefeller Plaza, 20th Floor, NEW YORK, NY, 10112, US

(73) Assignee: RICOH COMPANY, LTD, TOKYO (JP)

(21) Appl. No.: 12/180,916

(22) Filed: Jul. 28, 2008

(30) Foreign Application Priority Data
Aug. 9, 2007 (JP) 2007-208086

(51) Int. Cl. G03G 15/02

(52) U.S. Cl. 430/66

(57) ABSTRACT

A conductive member for use in an image forming apparatus, a process cartridge including the conductive member as a charging member, an image forming apparatus including the process cartridge, a charging member, and a process cartridge and an image forming apparatus including the charging member. The conductive member includes a surface coated with a powder lubricant. The charging member includes a conductive member and a powder lubricant applied to a surface of the conductive member.

### CROSS-REFERENCE TO RELATED APPLICATION

This patent specification is based on and claims priority from Japanese Patent Application No. 2007-208086, filed on Aug. 9, 2007 in the Japan Patent Office, the entire contents of which are hereby incorporated by reference herein.

### BACKGROUND

1. Field of the Invention

The present invention relates to a conductive member, and a process cartridge and an image forming apparatus including the conductive member.

2. Description of the Related Art

An image forming apparatus such as a copier, a laser beam printer, or a facsimile that forms an image using electrophotography includes a conductive member such as a charging member, a toner bearing member, a transfer member, and an image bearing member.

The charging member charges a latent electrostatic image bearing member. The transfer member performs transfer processing of toner on the latent electrostatic image bearing member. The image bearing member receives a toner image from the latent electrostatic image bearing member before the transfer processing.

FIG. 1 is a schematic diagram illustrating a part of an electrophotographic image forming apparatus.

As illustrated in FIG. 1, the image forming apparatus includes a latent electrostatic image bearing member 11, a charging member 12, a cleaning member 12a, a toner bearing member 14, a transfer member 16, a cleaning member 18, a development device 20, a cleaning device 21, and a lubricant application member 23. It should be noted that functional units necessary for electrophotographic image forming processes other than those described above are not relevant to the present invention and thus not illustrated in FIG. 1.

A latent electrostatic image is formed on the surface of the latent electrostatic image bearing member 11 by irradiating the surface of the latent electrostatic image bearing member 11 with light 13. The charging member 12 contacts or is disposed close to the latent electrostatic image bearing member 11 and charges the surface of the latent electrostatic image bearing member 11. The cleaning member 12a cleans the surface of the charging member 12. The toner bearing member 14 attaches toner 15 to the latent electrostatic image formed on the latent electrostatic image bearing member 11. The transfer member 16 transfers a toner image developed on the latent electrostatic image bearing member 11 to a recording medium 17. The cleaning member 18 cleans the surface of the latent electrostatic image bearing member 11 after transfer of the toner image. The development device 20 develops the latent electrostatic image formed on the latent electrostatic image bearing member 11 with toner to form the toner image. The cleaning device 21 removes toner remaining on the latent electrostatic image bearing member 11 after transfer of the toner image and stores the toner as a waste toner 19. The lubricant application member 23 applies a lubricant 22 to the surface of the latent electrostatic image bearing member 11 to reduce wear on the latent electrostatic image bearing member 11 caused by an electrical discharge and improve removal of toner thereon.

An image is formed by the image forming apparatus as follows:

1. The charging member 12 charges the surface of the latent electrostatic image bearing member 11 to a desired potential.

2. An irradiation device, not shown, irradiates the latent electrostatic image bearing member 11 with the light 13 to form a latent electrostatic image corresponding to a desired image on the latent electrostatic image bearing member 11.

3. The toner bearing member 14 develops the latent electrostatic image with the toner 15 to form a toner image (visual image) on the latent electrostatic image bearing member 11.

4. The transfer member 16 transfers the toner image on the latent electrostatic image bearing member 11 to the recording medium 17.

5. The cleaning device 21 removes toner remaining on the latent electrostatic image bearing member 11.

6. The recording medium 17 having the toner image transferred thereto by the transfer member 16 is conveyed to a fixing device, not shown. The fixing device fixes the toner onto the recording medium 17 by applying heat and pressure.

By repeating the above-described steps from 1 to 6, the desired image is formed on the recording medium 17.

The conductive member for use in the image forming apparatus is required to have physical surface properties such as low or high coefficient of friction or low adherence. When a foreign substance is attached to the surface of a conductive member disposed around the latent electrostatic image bearing member 11, a cleaning member contacting the conductive member removes the foreign substance from the conductive member.

A foreign substance is easily removed from a conductive member having a surface with a low coefficient of friction. However, a conductive member may be required to have a surface with a high coefficient of friction.

For example, the charging member, which is a conductive member, may have a surface with a coefficient of static friction of 1.0 or more to reduce formation of an abnormal image caused by a foreign substance such as toner, a toner additive, a lubricant, or a decomposition product thereof attached to the surface of the charging member.

However, a foreign substance attached to a conductive member having a surface with a high coefficient of friction is not easily removed and causes poor image formation. Such a problem particularly occurs in an early stage after assembly of the product (image forming apparatus) due to a foreign substance such as a resin powder (fragment) of a component included in the product. When the foreign substance is not removed by repeating image formation in a product test performed before delivery, the product needs to be readjusted and reassembled, thereby reducing yield rate.

The same problem may occur with an image forming apparatus using a charging member having a surface with a low coefficient of static friction, although not as frequently as the image forming apparatus using a charging member having a surface with a high coefficient of static friction. Specifically, a foreign substance such as a resin powder generated during assembly may not be removed from the charging member during a product test performed before delivery. In such a case, the product must be readjusted and reassembled due to the foreign substance.

### SUMMARY

Described herein is a novel conductive member for use in an image forming apparatus that includes a surface coated with a powder lubricant.

Further described herein is a novel process cartridge that includes the conductive member described above as a charging member.

Further described herein is a novel image forming apparatus that includes the process cartridge described above.

Further described herein is a novel charging member that includes a conductive member and a powder lubricant applied to a surface of the conductive member.

Further described herein is a novel process cartridge that includes the charging member described above.

Further described herein is a novel image forming apparatus that includes the charging member described above.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic diagram illustrating a part of a typical electrophotographic image forming apparatus;

FIG. 2 is a lateral cross-sectional diagram illustrating an example image forming apparatus capable of forming a full color image;

FIG. 3 is an enlarged cross-sectional diagram illustrating a process cartridge;

FIG. 4 is a schematic diagram illustrating relative positions of a charging roller, which is a conductive member, and a photosensitive layer area, an image forming area, and a non-image forming area of an image bearing member;

FIG. 5 is a model cross-sectional diagram illustrating the charging roller;

FIG. 6 is a schematic diagram illustrating a contact charging roller;

FIG. 7 is a model cross-sectional diagram illustrating the contact charging roller;

FIG. 8 is a scanning electron micrograph illustrating a surface of the charging roller before powder application;

FIG. 9 is a scanning electron micrograph illustrating the surface of the charging roller coated with a powder of silicon dioxide after excess powder is removed using compressed air; and

FIG. 10 is a schematic diagram illustrating generation of roller pitch spots.

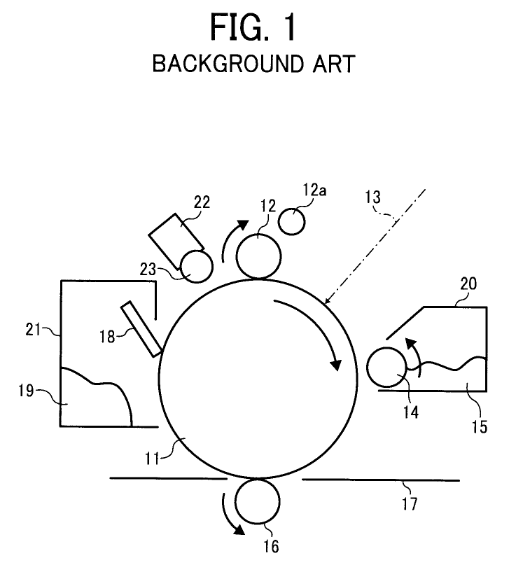

### DETAILED DESCRIPTION OF PREFERRED EMBODIMENTS

In describing preferred embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner and achieve a similar result.

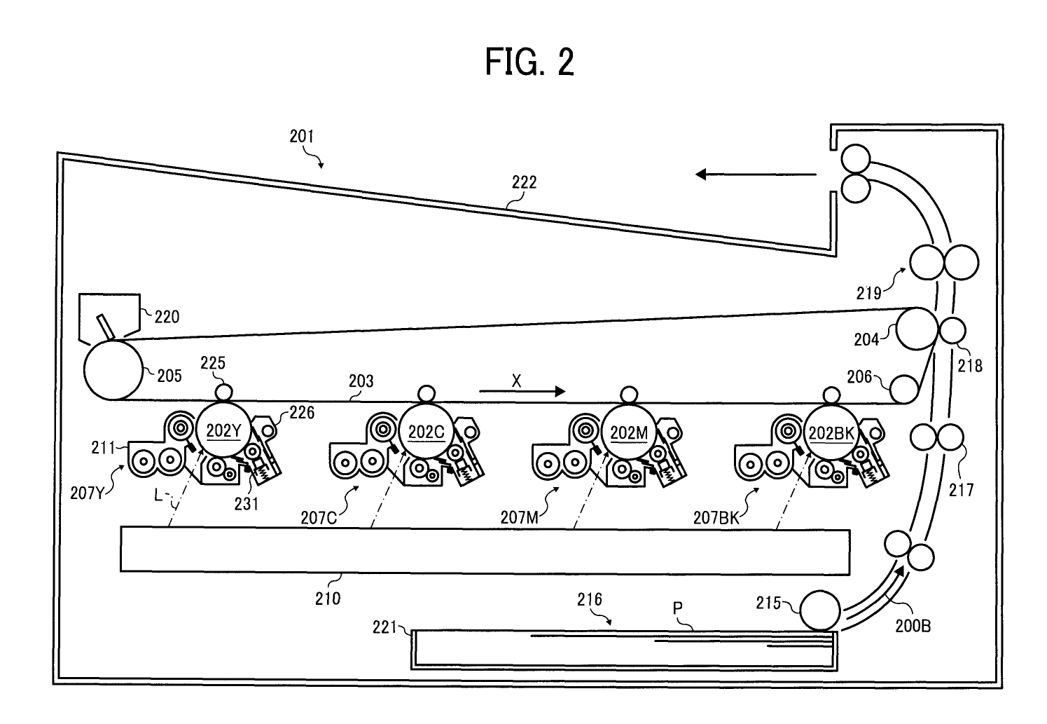

Referring now to the drawings, wherein like reference numerals and reference characters designate identical or corresponding parts throughout the several views thereof, particularly to FIG. 2, a conductive member, a process cartridge, and an image forming apparatus according to exemplary embodiments of the present invention are described.

It should be noted that a conductive member included in an image forming apparatus according to exemplary embodiments of the present invention is a charging roller serving as a charging member.

FIG. 2 is a lateral cross-sectional diagram illustrating an example image forming apparatus capable of forming a full color image. The image forming apparatus 201 includes an endless intermediate transfer belt 203 and process cartridges 207Y, 207C, 207M, and 207BK.

The intermediate transfer belt 203 is stretched around a plurality of support rollers 204, 205, and 206 and rotated in a direction indicated by arrow X shown in FIG. 2.

The process cartridges 207Y, 207C, 207M, and 207BK are disposed facing the intermediate transfer belt 203 and include image bearing members 202Y, 202C, 202M, and 202BK, respectively. The image bearing members 202Y, 202C, 202M, and 202BK are drum-shaped photosensitive units on which toner images of different colors are formed. The toner images formed on the image bearing members 202Y, 202C, 202M, and 202BK are transferred to and superimposed on the intermediate transfer belt 203 one atop another. The intermediate transfer belt 203 is an example of a transfer material to which the toner images formed on the image bearing members are transferred.

The process cartridges 207Y, 207C, 207M, and 207BK have substantially the same configuration to form a toner image on each of the image bearing members 202Y, 202C, 202M, and 202BK and transfer the toner image to the intermediate transfer belt 203. Therefore, to simplify the description, the configuration to form a toner image on the image bearing member 202Y of only the process cartridge 207Y and transfer the toner image to the intermediate transfer belt 203 is now described here. It should be noted, however, that the process cartridges 207Y, 207C, 207M, and 207BK merely use different colors of toner to form toner images.

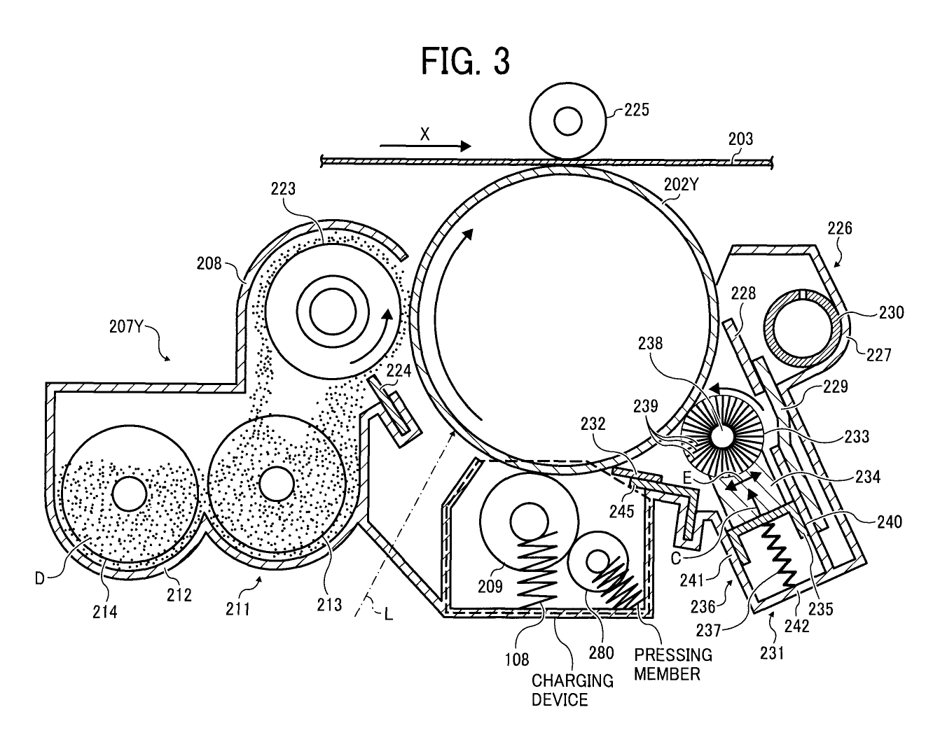

FIG. 3 is an enlarged cross-sectional diagram illustrating the process cartridge 207Y. As illustrated in FIG. 3, the image bearing member 202Y is rotatably supported in a unit case (housing of the process cartridge) 208 and rotated clockwise by a drive unit, not shown. A charging voltage is applied to a charging roller 209 rotatably supported in the unit case 208 to charge the surface of the image bearing member 202Y with a predetermined polarity. The charged image bearing member 202Y is irradiated with optically modulated laser light L emitted from an optical writing device 210 to form a latent electrostatic image on the image bearing member 202Y. The latent electrostatic image formed on the image bearing member 202Y is developed by a development device 211 to form a visible yellow toner image.

The development device 211 includes a development case 212, which is formed of a part of the unit case 208. The development case 212 contains a dry two-component developer D including a toner and a carrier. The development case 212 includes two screws 213 and 214 to agitate the developer D and a development roller 223 that is rotated counterclockwise in FIG. 3. The developer D moved onto the surface of the development roller 223 is conveyed thereon in the direction of rotation of the development roller 223. The developer D past a doctor blade 224 is conveyed to a development area between the development roller 223 and the image bearing member 202Y. In the development area, the toner included in the developer D is electrostatically transferred to the latent electrostatic image formed on the image bearing member 202Y, thereby visualizing the latent electrostatic image as a toner image. The developer D past the development area is separated from the development roller 223 and agitated by the screws 213 and 214. The toner image is thus formed on the image bearing member 202Y. A development device using a one-component developer not containing a carrier can also be used.

A primary transfer roller 225 is disposed opposite the process cartridge 207Y with the intermediate transfer belt 203 therebetween. A transfer voltage is applied to the primary transfer roller 225 to primarily transfer the toner image on the image bearing member 202Y to the intermediate transfer belt 203. The toner remaining on the image bearing member 202Y after transfer of the toner image is removed by a cleaning device 226.

The cleaning device 226 according to the present embodiment includes a cleaning case 227, a cleaning blade 228, a blade holder 229 holding the cleaning blade 228, and a toner conveyance screw 230 disposed in the cleaning case 227.

The cleaning case 227 is formed of a part of the unit case 208. The cleaning blade 228 is formed of an elastic body such as rubber. The cleaning blade 228 has a leading end pressed against the surface of the image bearing member 202Y. The leading end of the cleaning blade 228 is disposed in the direction opposite to the direction of movement of the surface of the image bearing member 202Y. The base end of the cleaning blade 228 is fixed to the blade holder 229 with, for example, an adhesive. The toner remaining on the image bearing member 202Y after transfer of the toner image is scraped and removed by the leading end of the cleaning blade 228. The removed toner is conveyed to the outside of the cleaning case 227 by the toner conveyance screw 230. The cleaning blade 228 thus cleans the image bearing member 202Y after the toner image is transferred to the intermediate transfer belt 203.

The process cartridge 207Y includes a lubricant application device 231 and a leveling blade 232.

The lubricant application device 231 applies a lubricant to the image bearing member 202Y. The leveling blade 232 is an example of a lubricant leveling unit that levels the lubricant applied to the image bearing member 202Y.

Similarly to the above description, a cyan toner image, a magenta toner image, and a black toner image are formed on the image bearing members 202C, 202M, and 202BK illustrated in FIG. 2, respectively. The cyan, magenta, and black toner images are primarily transferred to the intermediate transfer belt 203 such that the cyan, magenta, and black toner images are superimposed on the yellow toner image transferred to the intermediate transfer belt 203 one atop another, thereby forming a composite toner image on the intermediate transfer belt 203. As described above for the image bearing member 202Y, toner remaining on each of the image bearing members 202C, 202M, and 202BK after transfer of the toner image is removed by a cleaning device.

As illustrated in FIG. 2, a paper feed cassette 221 and a paper feed device 216 are disposed in a lower portion of the image forming apparatus 201. The paper feed cassette 221 contains recording media P such as transfer paper. The paper feed device 216 includes a paper feed roller 215. An uppermost recording medium P in the paper feed cassette 221 is sent in the direction indicated by arrow 200B shown in FIG. 2 by rotating the paper feed roller 215. Then, the recording medium P is timely fed by a pair of registration rollers 217 to an area between a stretched part of the intermediate transfer belt 203 around the support roller 204 and a secondary transfer roller 218 disposed opposite the stretched part. A predetermined transfer voltage is applied to the secondary transfer roller 218 to secondarily transfer the composite toner image on the intermediate transfer belt 203 to the recording medium P.

The recording medium P having the composite toner image secondarily transferred thereto is conveyed upward and passes through a fixing device 219 in which the toner image is fixed onto the recording medium P with heat and pressure. The recording medium P past the fixing device 219 is discharged to a discharge unit 222 disposed at the top of the image forming apparatus 201. The toner remaining on the intermediate transfer belt 203 after transfer of the toner image is removed by a cleaning device 220.

The lubricant application device 231 is provided to reduce wear on the cleaning blade 228 and the image bearing member 202Y. The lubricant application device 231 is also used to maintain a high level of cleaning ability of the cleaning blade 228 even when a spherical toner with a small particle diameter is used. Each of the process cartridges 207C, 207M, and 207BK includes a lubricant application device 231 having the same configuration and function as that of the process cartridge 207Y. Therefore, the lubricant application device 231 of the process cartridge 207Y is now described.

As illustrated in FIG. 3, the lubricant application device 231 includes a brush roller 233, a solid lubricant 234, a lubricant holder 235, a guide 236, and a compression coil spring 237.

The brush roller 233 contacts the surface of the image bearing member 202Y. The brush roller 233 includes a core 238 and a large number of brush fibers 239 having a base end fixed to the core 238. The brush roller 233 extends along and substantially parallel to the image bearing member 202Y. The core 238 is rotatably supported in the unit case 208 at both ends in the longitudinal direction thereof via bearings, not shown. The brush roller 233 is rotated counterclockwise in FIG. 3 during image formation.

The solid lubricant 234 is disposed facing the brush roller 233. The solid lubricant 234 is formed into a rectangular parallelepiped shape extending parallel to the brush roller 233. The leading end of the solid lubricant 234, which faces the brush roller 233, contacts the brush fibers 239 of the brush roller 233. The base end of the solid lubricant 234, which is opposite to the leading end, is fixed to the lubricant holder 235.

The guide 236 guides the solid lubricant 234 via the lubricant holder 235. The guide 236 includes a pair of opposed guide plates 240 and 241 disposed parallel to each other with a gap therebetween. The guide plates 240 and 241 are connected to each other by a connection plate 242. The pair of guide plates 240 and 241 and the connection plate 242 are formed as part of the unit case 208.

The lubricant holder 235 is disposed between the pair of guide plates 240 and 241 and slidably contacts the opposing surfaces of the guide plates 240 and 241.

The compression coil spring 237 is an example of a pressing member that presses the solid lubricant 234 against the brush roller 233 via the lubricant holder 235. The solid lubricant 234 is pressed against the brush roller 233 by a member such as a spring. In FIG. 3, the direction of pressing the solid lubricant 234 by the compression coil spring 237 is indicated by arrow C. A pressing member such as a torsion coil spring or a leaf spring may be used as a substitute for the compression coil spring 237.

As the brush roller 233 against which the solid lubricant 234 is pressed is rotated, the solid lubricant 234 is scraped by the brush fibers 239. Since the brush roller 233 is pressed against the image bearing member 202Y, a powder lubricant scraped by the brush fibers 239 is applied to the surface of the image bearing member 202Y. The brush roller 233 is thus used as an example of a lubricant supply member that supplies a powder lubricant scraped from the solid lubricant 234 to the surface of the image bearing member 202Y.

Although the solid lubricant 234 is scraped by the brush roller 233 and consumed, and therefore reduces a thickness thereof over time, the solid lubricant 234 continuously contacts the brush fibers 239 by using the compression coil spring 237 that presses the solid lubricant 234 against the brush roller 233.

By applying the lubricant to the surface of the image bearing member 202Y using the brush roller 233, the coefficient of friction of the surface of the image bearing member 202Y is reduced, thereby reducing wear on the image bearing member 202Y and the cleaning blade 228 and extending the life of the image bearing member 202Y and the cleaning blade 228. In addition, the cleaning ability of the cleaning blade 228 that cleans the image bearing member 202Y is not greatly reduced even when a spherical toner with a small particle diameter is used.

The solid lubricant 234 and the lubricant holder 235 are moved close to or away from the brush roller 233, i.e., in the direction indicated by arrow C (the direction of pressing the solid lubricant 234 with the compression coil spring 237) and in the direction opposite to the direction indicated by arrow C by using the guide 236. Therefore, the solid lubricant 234 is prevented from being greatly moved in the directions (indicated by E shown in FIG. 3) perpendicular to the direction indicated by arrow C. Consequently, the area of the solid lubricant 234 that contacts the brush roller 233 is always substantially the same, and therefore substantially the same amount of the lubricant is supplied to the surface of the image bearing member 202Y via the brush roller 233, thereby preventing uneven application of the lubricant to the surface of the image bearing member 202Y.

As illustrated in FIG. 3, the image forming apparatus 201 is configured such that the solid lubricant 234 is guided by the guide 236 via the lubricant holder 235 contacting the pair of guide plates 240 and 241. Alternatively, the solid lubricant 234 may be directly guided by the guide 236. It should be noted that the solid lubricant 234 is guided by the guide 236 such that the solid lubricant 234 is moved close to or away from the brush roller 233 in the direction indicated by arrow C or in the direction opposite to the direction indicated by arrow C with an allowance in E directions perpendicular thereto.

As described above, the lubricant application device 231 includes the lubricant supply member formed as the brush roller 233 that rotationally contacts the image bearing member 202Y, the solid lubricant 234 disposed facing the lubricant supply member, the guide 236 that guides the solid lubricant 234 to move the solid lubricant 234 close to or away from the lubricant supply member, and the pressing member that presses the solid lubricant 234 against the lubricant supply member.

Also, the image forming apparatus 201 includes the lubricant leveling unit formed as the leveling blade 232 as illustrated in FIG. 3. The leveling blade 232 is formed of an elastic body such as rubber, and has a leading end contacting the surface of the image bearing member 202Y and a base end fixed to a holder 245. The leveling blade 232 is disposed in the same direction as the direction of movement of the surface of the image bearing member 202Y. As can be seen from FIG. 3, the lubricant supply member formed as the brush roller 233 is disposed on the downstream side relative to the cleaning blade 228 in the direction of movement of the surface of the image bearing member 202Y.

In the above-described configuration, the toner remaining on the surface of the image bearing member 202Y after transfer of the toner image is removed by the cleaning blade 228. The lubricant is applied to the cleaned surface of the image bearing member 202Y by the brush roller 233. The applied lubricant is uniformly spread and evenly leveled on the surface of the image bearing member 202Y by the leveling blade 232 contacting the surface of the image bearing member 202Y while passing the leveling blade 232. Therefore, a lubricant layer with an even thickness is formed on the image bearing member 202Y. By applying and leveling the lubricant after the image bearing member 202Y is cleaned, variation in the amount of the lubricant applied to the surface of the image bearing member 202Y and variation in the coefficient of friction of the surface of the image bearing member 202Y are prevented, thereby improving the quality of an image formed on a recording medium. Also, by disposing the leveling blade 232 in the same direction as the direction of movement of the surface of the image bearing member 202Y, an excessive increase in drive torque of the image bearing member 202Y is prevented.

The brush fibers 239 preferably have a thickness of 3 to 8 deniers and a density of 20,000 to 100,000 fibers per square inch ((2.54 cm)²). Too thin brush fibers easily collapse when the brush roller 233 contacts the surface of the image bearing member 202Y. By contrast, when the brush fibers are too thick, the density thereof is reduced. When the density of the brush fibers 239 is too low, the lubricant cannot be evenly applied since the number of brush fibers contacting the surface of the image bearing member 202Y is reduced. By contrast, when the density of the brush fibers 239 is too high, a gap between the brush fibers 239 is reduced, thereby reducing the amount of the powder lubricant attached to the fibers and causing a shortage in the application amount of the lubricant.

As for the solid lubricant 234, a dry solid hydrophobic lubricant can be used. The solid lubricant 234 may be formed of a material including a stearate group such as zinc stearate, barium stearate, lead stearate, iron stearate, nickel stearate, cobalt stearate, copper stearate, strontium stearate, calcium stearate, cadmium stearate, and magnesium stearate. In addition, materials including a similar fatty acid group such as zinc oleate, manganese oleate, iron oleate, cobalt oleate, lead oleate, magnesium oleate, copper oleate, zinc palmitate, cobalt palmitate, copper palmitate, magnesium palmitate, aluminum palmitate, and calcium palmitate can be used. Further, fatty acids and metal salts of fatty acids such as lead caprylate, lead caproate, zinc linolenate, cobalt linolenate, calcium linolenate, and cadmium lycolinolenate, and waxes such as candelilla wax, carnauba wax, rice wax, haze wax, jojoba oil, beeswax, and lanolin can be used.

It should be noted that although the above-described image forming apparatus includes the drum-shaped image bearing member and uses the intermediate transfer belt as an intermediate transfer unit, the configuration according to the present invention is also applicable to an image forming apparatus including an image bearing member formed as an endless belt and a drum-shaped intermediate transfer unit.

Also, the configuration according to the present invention is applicable to an image forming apparatus using an intermediate transfer unit as an image bearing member on which a toner image is formed and a recording medium as a transfer material to which the toner image formed on the image bearing member is transferred. In this case, a cleaning blade that removes toner remaining on the intermediate transfer unit after transfer of the toner image and a lubricant application device that applies a lubricant to the intermediate transfer unit are provided according to the configuration of the present invention.

Further, the present invention is applicable to an image forming apparatus in which a toner image formed on a photosensitive unit serving as an image bearing member is directly transferred to a recording medium serving as a transfer material.

A charging device of the image forming apparatus is now described in detail.

### Charging Device

The charging device is illustrated as a portion enclosed by a dashed line in FIG. 3. The charging device includes the charging roller 209 and a cleaning member 280. The cleaning member 280 contacts and cleans the surface of the charging roller 209. The cleaning member 280 has a roller shape in the present example as illustrated in FIG. 3. Alternatively, the cleaning member 280 may have a pad shape. A rotation shaft of the cleaning member 280 engages a bearing provided to a housing, not shown, of the charging device so that the cleaning member 280 is rotatably supported by the housing. The cleaning member 280 is pressed against the surface of the charging roller 209 by a pressing member shown in FIG. 3 and cleans the outer circumferential surface of the rotating charging roller 209. The charging device includes a power source, not shown, to apply a voltage to the charging roller 209.

As for the voltage applied to the charging roller 209, it is preferable to superimpose an alternating-current (AC) voltage on a direct-current (DC) voltage. In non-contact charging, variation in a gap between the image bearing member and the charging roller easily causes uneven charging and application of only a DC voltage may cause uneven surface potential of the image bearing member. By applying an AC voltage superimposed on a DC voltage, the surface of the charging roller 209 becomes equipotential, thereby stabilizing electrical discharge and uniformly charging the image bearing member 202Y. It is preferable that a peak-to-peak voltage of the AC voltage to be superimposed is equal to or greater than twice a charging start voltage of the image bearing member 202Y. In this case, a reverse electrical discharge is generated from the image bearing member 202Y to the charging roller 209, which has a leveling effect, thereby enabling uniform charging of the image bearing member 202Y in a more stable condition. The value of the charging start voltage is an absolute value of the voltage at which the charging of the image bearing member 202Y starts by application of only a DC voltage to the charging roller 209. The AC voltage preferably has a frequency,of equal to or greater than seven times the circumferential velocity (processing speed) of the image bearing member 202Y to avoid a moire image.

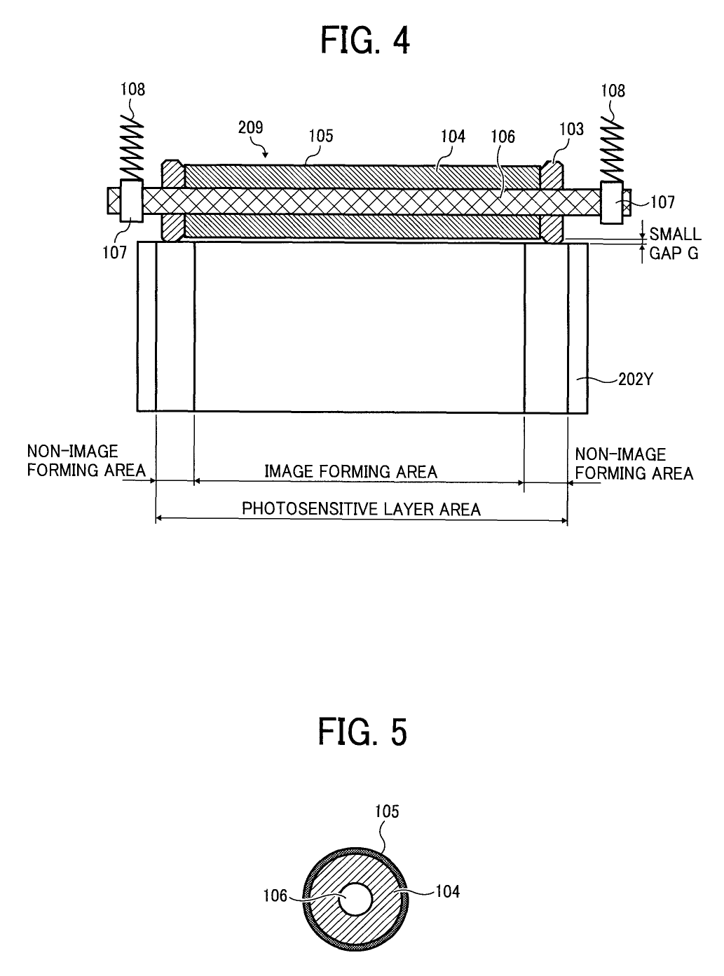

FIG. 4 is a schematic diagram illustrating relative positions of the charging roller 209, which is a conductive member, and a photosensitive layer area, an image forming area, and a non-image forming area of the image bearing member 202Y.

In the example illustrated in FIG. 4, the conductive member formed as the charging member is the cylinder-shaped charging roller 209. It should be noted that the charging member may have a belt-like shape, a blade-like (plate) shape, or a semi-cylindrical shape, in which case the charging member is fixed. The cylinder-shaped charging roller 209 may be rotatably supported at both ends thereof by gears or bearings. The charging roller 209 has a curved surface that gradually curves away from the image bearing member 202Y on the upstream and downstream sides relative to a point closest to the image bearing member 202Y in the direction of movement of the image bearing member 202Y, thereby uniformly charging the image bearing member 202Y. Were the charging member facing the image bearing member 202Y to have an acute portion, the potential of that portion would rise and an electrical discharge would start first at that portion, thereby preventing uniform charging of the image bearing member 202Y. Therefore, the charging member such as the charging roller 209 with its cylindrical shape and curved surface is used, enabling uniform charging of the image bearing member 202Y.

An electrical discharge places considerable stress on a discharging surface of the charging roller 209. When an electrical discharge is continuously generated on the same surface of the charging roller 209, degradation of the discharging surface is accelerated and the discharging surface may peel off. Regardless of non-contact charging or contact charging, by rotating the charging roller 209 and using the entire surface of the charging roller 209 as the discharging surface, the stress is dispersed over the entire surface, early degradation of the charging roller 209 is prevented, and the charging roller 209 can be used over an extended period of time.

The charging roller 209 is disposed opposite the image bearing member 202Y with a small gap G therebetween as illustrated in FIG. 4. The small gap G is formed by a gap retaining member 103 contacting the non-image forming area of the image bearing member 202Y. The gap retaining member 103 contacting the non-image forming area included in the photosensitive layer area prevents variation in the amount of the small gap G even when the application thickness of the photosensitive layer of the image bearing member 202Y varies.

FIG. 5 is a model cross-sectional diagram illustrating an example of a non-contact charging roller. The gap retaining member 103 is disposed on each end of an electric resistance adjusting layer 104 formed on a conductive support member 106. A protection layer 105 is formed on the surface of the electric resistance adjusting layer 104 to prevent attachment of toner and a toner additive thereto.

### Proximity Disposition Method, and Gap and Gap Forming Method

When the charging roller 209 is disposed in proximity to the image bearing member 202Y, the small gap G formed therebetween is preferably equal to or smaller than 100 μm, and more preferably approximately 5 to 70 μm, to prevent formation of an abnormal image.

When the small gap G is greater than 100 μm, i.e., when the distance between the charging roller 209 and the image bearing member 202Y is too large, an electrical discharge start voltage according to Paschen's law is increased. In addition, since an electrical discharge space between the charging roller 209 and the image bearing member 202Y is increased, a large amount of an electrical discharge product is generated by an electrical discharge to charge the image bearing member 202Y to a predetermined voltage. The large amount of the electrical discharge product remains in the electrical discharge space after image formation and is attached to the image bearing member 202Y, thereby accelerating degradation of the image bearing member 202Y over time.

When the small gap G is too small, i.e., when the distance between the charging roller 209 and the image bearing member 202Y is too short, the image bearing member 202Y can be charged with little electrical discharge energy. However, the space between the charging roller 209 and the image bearing member 202Y is reduced, thereby reducing the flow of air therethrough. Therefore, similarly to the case in which the small gap G is too large, the large amount of the electrical discharge product generated in the electrical discharge space remains in the electrical discharge space after image formation and is attached to the image bearing member 202Y, thereby accelerating degradation of the image bearing member 202Y over time.

Therefore, it is preferable to reduce generation of the electrical discharge product by reducing the electrical discharge energy and form the electrical discharge space such that the air flows therethrough. With the small gap G equal to or smaller than 100 μm, and more preferably, approximately 5 to 70 μm, generation of a streamer discharge and the electrical discharge product is reduced, and therefore the amount of the electrical discharge product accumulated on the image bearing member 202Y is reduced. Consequently, spots and blurs are prevented from being formed in the image.

As illustrated in FIGS. 3 and 4, each end of the charging roller 209 engages a bearing 107 provided to a side plate of the housing, not shown, of the charging device. The bearing 107 is formed of a resin with a low coefficient of friction. A compression spring 108 is disposed on the bearing 107 to press the charging roller 209 in the direction toward the surface of the image bearing member 202Y. Consequently, the constant small gap G is formed even with mechanical oscillation or eccentricity of a core of the charging roller 209. A load applied to the charging roller 209 by the compression spring 108 is 4 to 25 N, or preferably, 6 to 15 N. Although the charging roller 209 is fixed by the bearing 107, the small gap G may vary in amount due to oscillation during rotation of the charging roller 209, eccentricity of the core of the charging roller 209, and a concavo-convex portion on the surface of the charging roller 209. When the small gap G deviates from a proper range, degradation of the image bearing member 202Y is accelerated over time.

There is a difference in height between a portion of the gap retaining member 103 contacting the electric resistance adjusting layer 104 and the electric resistance adjusting layer 104. The difference is formed with high precision by simultaneously manufacturing the gap retaining member 103 and the electric resistance adjusting layer 104 by, for example, removal processing such as cutting or grinding.

Specifically, the radius of the contacting portion of the gap retaining member 103 is formed to be substantially equal to or smaller than that of the electric resistance adjusting layer 104, thereby reducing a portion of the gap retaining member 103 contacting the image bearing member 202Y and forming the small gap G with high precision. Consequently, the outer surface of an end of the gap retaining member 103 adjacent to the electric resistance adjusting layer 104 is prevented from contacting the image bearing member 202Y, thereby preventing generation of a leakage current, which is generated when the electric resistance adjusting layer 104 contacts the image bearing member 202Y via the end of the gap retaining member 103.

A clearance for a cutting blade used in the removal processing is provided by forming the difference in height between the gap retaining member 103 and the electric resistance adjusting layer 104. The clearance can have any shape as long as the outer surface of the end of the gap retaining member 103 does not contact the image bearing member 202Y.

Further, it is difficult to control masking for coating the surface of the electric resistance adjusting layer 104 by defining the border between the electric resistance adjusting layer 104 and the gap retaining member 103 due to manufacturing tolerances. Therefore, a surface layer is formed on the electric resistance adjusting layer 104 by masking over the electric resistance adjusting layer 104 and the end of the gap retaining member 103 with a radius substantially equal to or smaller than that of the electric resistance adjusting layer 104.

### Gap Retaining Member

The gap retaining member 103 is used to stably form the small gap G between the charging roller 209 and the image bearing member 202Y under any environment over a long period of time. It is preferable to select the material of the gap retaining member 103 according to various conditions. For example, it is preferable that the gap retaining member 103 be formed of a material having low hygroscopicity and low wear resistance. Also, it is preferable that the material of the gap retaining member 103 prevent attachment of toner and a toner additive thereto and wear on the image bearing member 202Y since the gap retaining member 103 contacts and slides on the image bearing member 202Y. Example materials of the gap retaining member 103 include general-purpose resins such as polyethylene (PE), polypropylene (PP), polyacetal (POM), polymethylmethacrylate (PMMA), polystyrene (PS), copolymers thereof (AS and ABS), polycarbonate (PC), urethane, and fluorine (PTFE). It is preferable to use an adhesive to securely fix the gap retaining member 103. Also, the gap retaining member 103 is preferably formed of an insulating material with a volume resistivity of equal to or greater than 10¹³ Ωcm to prevent generation of a leakage current between the gap retaining member 103 and the image bearing member 202Y. The gap retaining member 103 is formed by molding.

### Electric Resistance Adjusting Layer

The electric resistance adjusting layer 104 is formed of a thermoplastic resin composition in which ion conductive polymers are dispersed. The electric resistance adjusting layer 104 preferably has a volume resistivity of 10⁶ to 10⁹ Ωcm. When the volume resistivity is too large, the electric resistance adjusting layer 104 may have insufficient charging ability and transfer ability. When the volume resistivity is too small, the electric resistance adjusting layer 104 may cause a leakage current due to concentration of electric current on the entire image bearing member 202Y.

The thermoplastic resin included in the electric resistance adjusting layer 104 is not particularly limited. General-purpose resins such as polyethylene (PE), polypropylene (PP), polymethylmethacrylate (PMMA), polystyrene (PS), copolymers thereof (AS and ABS), polyamide, and polycarbonate (PC) are easily molded and therefore preferable as the material of the electric resistance adjusting layer 104.

The ion conductive polymer dispersed in the thermoplastic resin is preferably a polymer containing a polyether ester amide component. The polyether ester amide is a polymer material having an ion conductive property and is uniformly dispersed and immobilized in a polymer matrix at a molecular level. Therefore, unlike compositions in which an electron-conductive agent such as metal oxide or carbon black is dispersed, variation in the resistivity value is not caused by insufficient dispersion. When a high voltage is applied to the conductive member including the electron-conductive agent, a path through which an electric current easily flows is locally formed, thereby generating a leakage current flowing to the image bearing member 202Y, and, when the conductive member is the charging member, an abnormal image with a white or black spot is formed. Since the polyether ester amide is a polymer, bleed-out hardly occurs. The electric resistance adjusting layer 104 includes 20 to 70 weight percent thermoplastic resin and 80 to 20 weight percent ion conductive polymer to have a desired resistivity value.

To adjust the resistivity value, an electrolyte (salt) may be added to the materials of the electric resistance adjusting layer 104. As for the salt, example materials include alkali metal salts such as sodium perchlorate and lithium perchlorate, lithium imide salts such as lithium bisimide and lithium trismethide, and quaternary phosphonium salts such as ethyltriphenyl phosphonium tetrafluoroborate and tetraphenyl phosphonium bromide. A single conductive agent or a mixture of a plurality of conductive agents can be used as long as the properties of the conductive material are not lost.

To uniformly disperse a conductive material in a polymer matrix at a molecular level, a compatibilizer that enables microdispersion of the conductive material may be used. The compatibilizer includes a material containing a glycidyl methacrylate group as a reactive group. In addition, an additive such as an antioxidant may be used as long as the properties of the conductive material are not lost.

A manufacturing method of the resin composition is not particularly limited. The resin composition is easily manufactured by mixing, melting, and kneading materials using a biaxial kneading machine or a kneader.

The electric resistance adjusting layer 104 is formed on the conductive support member 106 by coating the conductive support member 106 with the conductive resin composition by, for example, extrusion molding or injection molding.

When the conductive member includes only the conductive support member 106 and the electric resistance adjusting layer 104 formed on the conductive support member 106, toner and a toner additive are easily attached to the electric resistance adjusting layer 104, thereby degrading performance of the conductive member. Such a problem is prevented by forming a surface layer on the electric resistance adjusting layer 104.

In an image forming apparatus using contact charging, a charging member is formed of an elastic body. In this case, an elastic electric resistance adjusting layer is formed by adding various conductive agents to a rubber material such as silicone, NBR, epichlorohydrin, or EPDM. The rubber material is processed by a typically used technique.

### Surface Layer

To prevent attachment of toner and a,toner additive to the surface layer, slippage of the cleaning member contacting the surface of the charging roller is prevented. The surface of the charging roller has a high coefficient of friction to prevent slippage of the cleaning member. The surface layer is formed of a material including a metal oxide such as carbon black, zinc oxide, and tin oxide, or a conductive agent such as an ion conductive agent, to have a conductivity.

The surface layer is formed by a known coating method such as spray coating, dipping, or roll coating.

The present invention is particularly suitable for reducing formation of an abnormal image caused by toner, a toner additive, a lubricant, and a decomposition product thereof attached to the surface of the charging member having the surface with a coefficient of static friction of equal to or greater than 1.0. In such a case, the present invention achieves a large effect. It should be noted that the present invention is also applicable to a conductive member having a typical surface layer and similarly achieves a large effect.

### Application Powder

A powder lubricant is applied to the surface of the conductive member (charging roller) to reduce the coefficient of friction and adherence thereof. Examples of the powder lubricant include metallic soaps, fluorine-containing resins, molybdenum-containing compounds, inorganic oxides, and typical toner for use in an image forming apparatus.

As the metallic soaps, lithium stearate, aluminum stearate, lithium laurate, and zinc laurate can be used.

As the fluorine-containing resins, polyvinylidene-fluoride (PVDF), polytetrafluoroethylene (PTFE), tetrafluoroethylene-perfluoropropyl vinyl ether (PFA), ethylene tetrafluoroethylene copolymer (ETFE), and tetrafluoroethylene-hexafluoropropylene copolymer (FEP) can be used.

As the molybdenum-containing compounds, molybdenum disulfide, molybdenum dialkyldithiocarbamate sulfide, and oxymolybdenum sulfide dialkyl dithiophosphate can be used.

As the inorganic oxides, silicon dioxide, titanium oxide, and aluminum oxide can be used. A titanium oxide having a catalytic ability may cause a problem in the embodiment of the present invention. Therefore, it is preferable to use a titanium oxide that does not have a catalytic ability.

In addition to the above-described powder lubricant, a lubricant that does not cause a problem while being used in the image forming apparatus may be used.

Further, toner (powder including a core of resin and an inorganic oxide provided to the surface of the core) that visualizes a latent electrostatic image in the image forming apparatus such as an electrophotographic device can be used as the powder lubricant.

The toner is formed by a pulverization method or a polymerization method. The toner is formed of composite powder particles including resins such as polyester and particles of inorganic oxide such as SiO₂ or TiO₂ externally added to the resins. Since the composite powder particles have a low cohesiveness and a high fluidity, the composite powder particles are easily handled and therefore suitably used in the embodiment of the present invention.

The powder used in the embodiment of the present invention preferably has a particle diameter of 0.1 to 100 μm for easy handling.

The application method of the powder to the surface of the conductive member is not particularly limited. For example, the powder may be applied to the conductive member by sprinkling the powder or spraying the powder using air. However, excess powder may cause a problem in the image forming apparatus. Therefore, it is preferable to remove the excess powder by, for example, blowing the excess powder using compressed air or wiping off the excess powder with a cloth as long as the effect of the present invention is not lost.

In the present invention, the powder is applied to the conductive member to reduce an adherence of the conductive member during assembly of the conductive member to the image forming apparatus and in an early stage after first operation. Therefore, the powder is temporarily attached to the surface of the conductive member and functions in the early stage. It should be noted that the powder is removed by, for example, a cleaning mechanism after the image forming apparatus is actually used so that the surface of the conductive member exhibits inherent properties thereof.

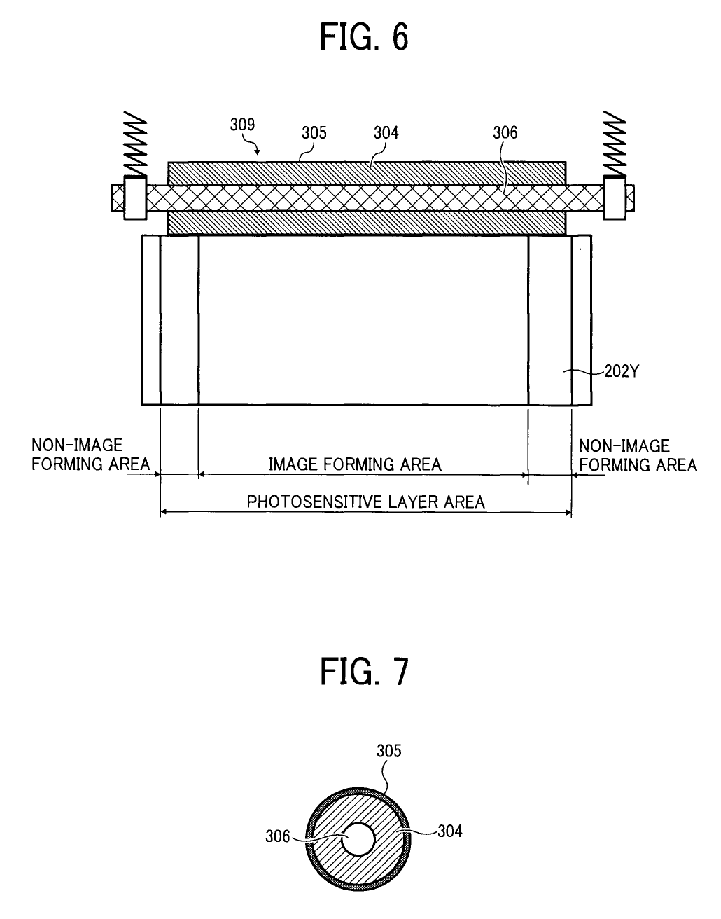

In the example illustrated in FIG. 4, the image forming apparatus uses the above-described proximity disposition method, i.e., a gap is formed between the charging member and the image bearing member. However, it should be noted that the present invention is also applicable to an image forming apparatus using a contact method, i.e., an image forming apparatus in which a contact charging roller 309 directly contacts the image bearing member 202Y as illustrated in FIG. 6.

FIGS. 6 and 7 are schematic diagrams illustrating an example of the contact charging roller 309. As illustrated in FIGS. 6 and 7, an electric resistance adjusting layer 304 is formed on a conductive support member 306 and a protection layer 305 is formed on the surface of the electric resistance adjusting layer 304 to prevent attachment of toner and a toner additive thereto. The above-described powder is applied to the surface of the protection layer 305.

### EXAMPLES

Examples of the conductive member according to the present invention are now described.

### Conductive Member A (a Non-Contact Charging Roller for an Image Forming Apparatus Using the Proximity Disposition Method)

A support member (a 10 mm diameter cylinder) of nickel-plated stainless steel is used as the conductive support member. An electric resistance adjusting layer formed of a resin composition with a hollow cylindrical shape is formed on the support member by injection molding.

The resin composition is prepared by adding 4 parts by weight of polycarbonate-grycidylmethacrylate styrene acrylonitrile copolymer (Modiper C L440-G manufactured by NOF Corporation) to 100 parts by weight of base resin, formed of 40 weight percent ABS resin (GR 3000 manufactured by Denki Kagaku Kogyo Co., Ltd.) and 60 weight percent polyether ester amide (IRGASTAT P18 manufactured by Chiba Specialty Chemicals Co., Ltd.), which is then melted and kneaded. After gate cutting and length adjustment of the electric resistance adjusting layer, a ring-shaped gap retaining member is pressed into both ends of the electric resistance adjusting layer. The gap retaining member is formed of high-density polyethylene resin (Novatec PP HY 540 manufactured by Japan Polychem Corporation). Then, the gap retaining member and the electric resistance adjusting layer are simultaneously cut so that the gap retaining member has an outer diameter of 12.5 mm and the electric resistance adjusting layer has an outer diameter of 12.4 mm, respectively. At this point, the conductive member including the support member, the electric resistance adjusting layer, and the gap retaining member is the same as a typical charging roller and has a surface with a coefficient of static friction of less than 1.0.

Then, a surface layer with a layer thickness of approximately 10 μm is formed on the electric resistance adjusting layer. The surface layer is formed by spraying a coating material diluted in a diluting solvent onto the electric resistance adjusting layer. The coating material is formed of a mixture of acrylic modified silicone resin (Mukicoat 3000VH manufactured by Kawakami Paint Manufacturing Co., Ltd.), an ion conductive agent (PEL20A manufactured by Japan Carlit Corporation), and isocyanate resin (T4 hardener manufactured by Kawakami Paint Manufacturing Co., Ltd.). The diluting solvent is formed of butyl acetate, toluene, and methyl ethyl ketone (MEK).

The conductive member having the surface layer is then heated and hardened in a hot air oven at a temperature of 105° C. for 60 minutes, thereby obtaining a roller-shaped conductive member A with a difference in height of approximately 40 μm between the gap retaining member and the surface layer.

### Conductive Member B (a Contact Charging Roller for an Image Forming Apparatus Using the Contact Method)

A stainless-steel core (with an outer diameter of 8 mm) is used as the conductive support member. The core is coated with a rubber composition formed of 100 parts by weight of epichlorohydrin rubber (Epichlomer CG manufactured by Daiso Co., Ltd.) combined with 3 parts by weight of ammonium perchlorate through extrusion molding and vulcanization. The rubber composition is ground to form an electric resistance adjusting layer with an outer diameter of 12 mm.

A surface layer with a layer thickness of approximately 10 μm is formed on the electric resistance adjusting layer. The surface layer is formed by spraying a coating material diluted in a diluting solvent onto the electric resistance adjusting layer. The coating material is formed of a mixture of a resin solution in which fluorine resin (Lumiflon 601C manufactured by Asahi Glass Co., Ltd.) and epichlorohydrin rubber (Epichlomer CG manufactured by Daiso Co., Ltd.) dissolve in a toluene solution, and isocyanate resin (Lumiflon 601C hardener manufactured by Asahi Glass Co., Ltd.).

The diluting solvent is formed of toluene and xylene.

Then, the conductive member having the surface layer is heated and hardened in a hot air oven at a temperature of 105° C. for 60 minutes, thereby obtaining a conductive member B.

TABLE 1 shows results of the experiment conducted by applying various powders to the surface of the conductive member A or B.

The powder is applied to the image forming area illustrated in FIG. 4 or FIG. 6. Specifically, the application area of the powder to the non-contact charging roller is an area coated with the surface layer between the gap retaining members (see FIG. 4) and the application area of the powder to the contact charging roller is an area coated with the surface layer (see FIG. 6).

The powder lubricant is sprinkled over an entire area of the conductive member A or B and excess powder lubricant is removed using compressed air. The excess solid lubricant on the conductive member may cause a problem in a process cartridge or an image forming apparatus and therefore is undesirable.

Scanning electron micrographs of the surface of the conductive member before and after application of the solid lubricant confirm that the solid lubricant remains on the surface of the conductive member after the excess powder lubricant is removed. With a colored powder, the remaining solid lubricant is confirmed by wiping the surface of the conductive member with tissue paper.

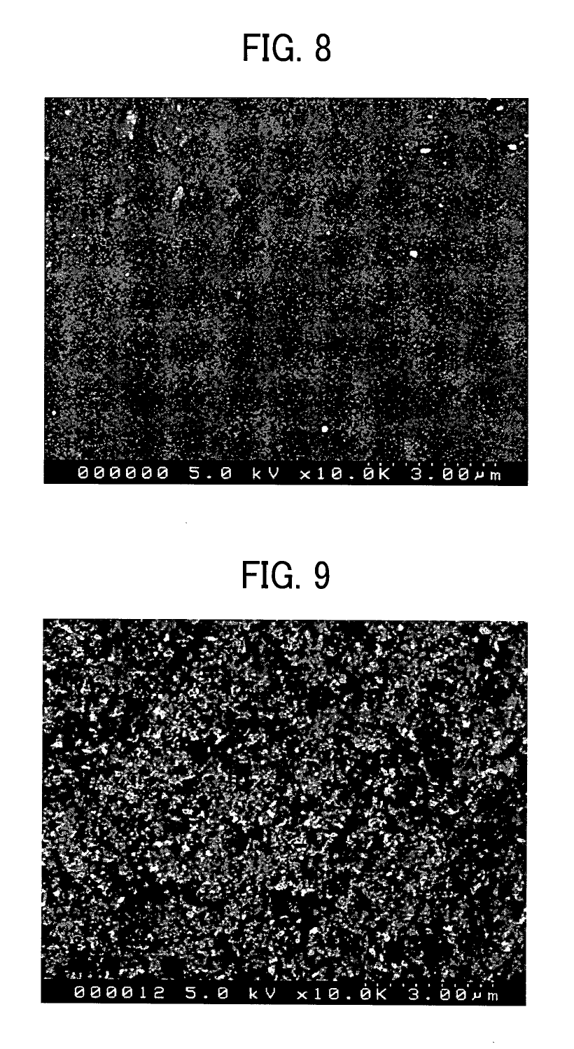

FIG. 8 is a scanning electron micrograph illustrating the surface of the charging roller before the powder application and FIG. 9 is a scanning electron micrograph illustrating the surface of the charging roller coated with a powder of silicon dioxide after excess powder is removed using compressed air. As can be seen from FIGS. 8 and 9, the powder remains on the surface of the charging roller after the excess powder is removed using compressed air.

TABLE 1

| | Conductive | | |
|---|---|---|---|
| | member | Powder | Evaluation |
| Example 1 | A | Aluminum stearate | Good |
| | | (manufactured by Nitto | |
| | | Kasei Co., Ltd.) | |
| Example 2 | A | PVDF (Kynar 301F | Good |
| | | manufactured by Arkema | |
| | | Inc.) | |
| Example 3 | A | Molybdenum disulfide (Moly | Excellent |
| | | Powder PA manufactured by | |
| | | Sumico Lubricant Co., Ltd.) | |
| Example 4 | A | Aluminum oxide (AA03 | Excellent |
| | | manufactured by Sumitomo | |
| | | Chemical Co., Ltd.) | |
| | | Particle diameter: 0.3 μm | |
| Example 5 | B | Silicon dioxide (H1303 | Excellent |
| | | manufactured by Wacker | |
| | | Asahikasei Silicone Co., | |
| | | Ltd.) Primary particle | |
| | | diameter: 20 nm, Secondary | |
| | | particle diameter: less | |
| | | than 20 μm | |
| Example 6 | B | Toner for a copier (Imagio | Excellent |
| | | Toner Type C1 manufactured | |
| | | by Ricoh Co., Ltd.) | |
| | | Particle diameter: | |
| | | approximately 6 μm | |
| Comparative | A | None | Poor |
| example 1 | | | |
| Comparative | B | None | Poor |
| example 2 | | | |

### Evaluation Test

The above-described roller-shaped conductive member A or B is used as a charging roller. A resin powder with a diameter of equal to or less than 2 mm is attached to the surface of the charging roller to serve as a foreign substance such as a fragment generated during manufacturing of the image forming apparatus. The resin powder is an ABS resin powder used in a process cartridge or an image forming apparatus. The attached resin powder particles are on the order of several hundreds.

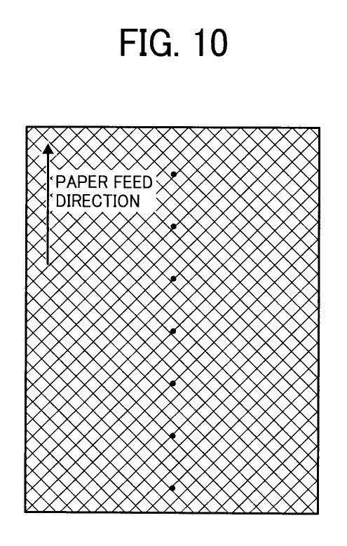

Then, the charging roller is installed in the process cartridge illustrated in FIG. 3 and the process cartridge is installed in the image forming apparatus (in this case, imagio MP C3000 manufactured by Ricoh Co., Ltd.) illustrated in FIG. 2. An A3-size one-by-one halftone image of 600 dpi is continuously output on ten sheets of paper using the image forming apparatus as in a product test performed after manufacturing of the image forming apparatus,and generation of dark roller pitch spots on the output halftone image is visually observed. FIG. 10 is a schematic diagram illustrating the roller pitch spots generated along the paper feed direction.

As for the evaluation index, no spot observed after printing on ten sheets of paper is evaluated as Excellent, four or less spots remaining on the tenth sheet as Good, and five or more spots remaining on the tenth sheet as Poor.

As can be seen from TABLE 1, the resin powder is entirely or substantially entirely removed by forming images on ten sheets of paper in the evaluation test. As described above, the resin powder particles attached to the surface of the charging roller are on the order of several hundreds, which is greater than the amount of powder assumed at a start of operation after actual assembly of the apparatus. Therefore, a better result is expected in actual operation. Also, application of the powder lubricant to the charging roller does not cause any problem.

As can be understood by those skilled in the art, numerous additional modifications and variations are possible in light of the above teachings. It is therefore to be understood that, within the scope of the appended claims, the disclosure of this patent specification may be practiced otherwise than as specifically described herein.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program or computer program product. For example, the aforementioned methods may be embodied in the form of a system or device, including, but not limited to, any of the structures for performing the methodology illustrated in the drawings.

Example embodiments being thus described, it will be apparent that the same may be varied in many ways. Such variations are not to be regarded as a departure from the spirit and scope of the present invention, and all such modifications as would be obvious to one skilled in the art are intended to be included within the scope of the following claims.

What is claimed is:

1. A conductive member for use in an image forming apparatus comprising a surface coated with a powder lubricant.

2. The conductive member according to claim 1,
wherein the powder lubricant comprises at least one of a metallic soap, a fluorine-containing resin, a molybdenum-containing compound, an inorganic oxide, and a toner for use in an image forming apparatus.

3. The conductive member according to claim 2,
wherein the metallic soap comprises at least one of lithium stearate, aluminum stearate, lithium laurate, and zinc laurate.

4. The conductive member according to claim 2,
wherein the fluorine-containing resin comprises at least one of polyvinylidene-fluoride, polytetrafluoroethylene, tetrafluoroethylene-perfluoropropyl vinyl ether, ethylene tetrafluoroethylene copolymer, and tetrafluoroethylene-hexafluoropropylene copolymer.

5. The conductive member according to claim 2,
wherein the molybdenum-containing compound comprises at least one of molybdenum disulfide, molybdenum dialkyldithiocarbamate sulfide, and oxymolybdenum sulfide dialkyl dithiophosphate.

6. The conductive member according to claim 2,
wherein the inorganic oxide comprises at least one of silicon dioxide, titanium oxide, and aluminum oxide.

7. The conductive member according to claim 1, being a charging member configured to charge a surface of an image bearing member.

8. A process cartridge comprising the charging member of claim 7.

9. The process cartridge according to claim 8, further comprising a cleaning member contacting a surface of the charging member.

10. The process cartridge according to claim 8,
wherein the charging member is a rotating body.

11. An image forming apparatus comprising the process cartridge of claim 8.

12. A charging member comprising:
a conductive member; and
a powder lubricant applied to a surface of the conductive member.

13. A process cartridge comprising the charging member of claim 12.

14. An image forming apparatus comprising the charging member of claim 12.
